(19) United States
(12) Patent Application Publication
(10) Pub. No.: US 2025/0231069 A1
(43) Pub. Date: Jul. 17, 2025

(54) PHASE CHANGE AMOUNT ESTIMATION DEVICE

(71) Applicant: Mitsubishi Electric Corporation, Tokyo (JP)

(72) Inventor: Yukari Miyagi, Tokyo (JP)

(73) Assignee: Mitsubishi Electric Corporation, Tokyo (JP)

(21) Appl. No.: 19/098,194

(22) Filed: Apr. 2, 2025

Related U.S. Application Data
(63) Continuation of application No. PCT/JP2022/044802, filed on Dec. 6, 2022.

(51) Int. Cl. G01J 9/02

(52) U.S. Cl. CPC G01J 9/02

(57) ABSTRACT

A phase change amount estimation device includes: a light source emitting light; a quantum switch outputting the light from the light source to a first optical path in which the light is made to pass through in the order of a first environmental system, a measurement target object, and a second environmental system, or a second optical path in which the light is made to pass through in the order of the second environmental system, the measurement target object, and the first environmental system, in accordance with the quantum state of the light from the light source; and a phase change amount estimation unit estimating the amount of phase change in the light, the phase change being caused because of the light passing through the measurement target object, from the light which has passed through the first optical path or the light which has passed through the second optical path.

### CROSS REFERENCE TO RELATED APPLICATIONS

This application is a Continuation of PCT International Application No. PCT/JP2022/044802 filed on Dec. 6, 2022, all of which is hereby expressly incorporated by reference into the present application.

### TECHNICAL FIELD

The present disclosure relates to a phase change amount estimation device.

### BACKGROUND ART

There are phase change amount estimation devices which estimate the amount of phase change in light, the phase change being caused because of the light passing through an object to be measured or the reflection of the light by an object to be measured.

As such a phase change amount estimation device, a device including a light source, an optical splitter means, a phase modulation means, an optical combination means, a light intensity measurement means, and a calculation means is disclosed in Patent Literature 1.

The optical splitter means splits light emitted from the light source into two light beams, and outputs one of the light beams after splitting to the phase modulation means as reference light while outputting the other one of the light beams after splitting to an object to be measured as signal light. The phase modulation means performs a phase modulation on the reference light outputted from the optical splitter means. The optical combination means combines the signal light which has passed through the object to be measured and the reference light on which the phase modulation is performed by the phase modulation means. The light intensity measurement means measures the intensity of interference light which is the light after the combining by the optical combination means. The calculation means estimates the amount of phase change in the signal light, the phase change being caused because of the light passing through the object to be measured, on the basis of the intensity measured by the light intensity measurement means.

### CITATION LIST

### Patent Literature

Patent Literature 1: JP 2012-132838 A

### SUMMARY OF INVENTION

### Technical Problem

In the intensity of the light which has passed through the object to be measured, Fisher information, which is the amount of information about the amount of phase change in the light, is contained, and the estimation accuracy of the phase change in the light improves as the Fisher information increases. The Fisher information is determined on the basis of both the noise conditions of an environmental system through which the light emitted from the light source passes and the time of the interaction between the light emitted from the light source and the environmental system, for example.

In the phase change amount estimation device disclosed in Patent Literature 1, there is a problem that it is impossible to increase the Fisher information contained in the intensity measured by the light intensity measurement means.

The present disclosure is made in order to solve the above-mentioned problem, and it is therefore an object of the present disclosure to provide a phase change amount estimation device that can improve the estimation accuracy of the phase change amount by increasing the Fisher information compared to that in the phase change amount estimation device disclosed in Patent Literature 1.

### Solution to Problem

A phase change amount estimation device according to the present disclosure includes: a light source to emit incoherent light; a quantum switch having an optical demultiplexer, the incoherent light emitted from the light source entering an incident surface of the optical demultiplexer, the optical demultiplexer being configured to reflect the incoherent light or allow the incoherent light to pass through the optical demultiplexer, the quantum switch having a first environmental system, and a second environmental system, an object to be measured being arranged between the first environmental system and the second environmental system, and, by the quantum switch, a quantum mechanical superposition is achieved by forming either one of a first optical path in which the incoherent light, after being reflected by the optical demultiplexer, is made to pass through in an order of a first environmental system, an object to be measured, and a second environmental system, or a second optical path in which the incoherent light passed through the optical demultiplexer is made to pass through in an order of the second environmental system, the object to be measured, and the first environmental system; and a phase change amount estimator having a first optical detector to detect intensity of the incoherent light which has passed through the first optical path, a second optical detector to detect intensity of the incoherent light which has passed through the second optical path, and a change amount estimation processing circuitry to estimate an amount of phase change in a light, the phase change being caused by the light passing through the object to be measured, from the intensity of the light detected by the first optical detector or the intensity of the light detected by the second optical detector.

### Advantageous Effects of Invention

According to the present disclosure, it is possible to improve the estimation accuracy of the phase change amount by increasing the Fisher information compared to that in the phase change amount estimation device disclosed in Patent Literature 1.

### BRIEF DESCRIPTION OF DRAWINGS

FIG. 1 is a block diagram showing a phase change amount estimation device according to Embodiment 1;

FIG. 2A is an explanatory drawing showing an event when a quantum state ρ_{c} is |1><1|, FIG. 2B is an explanatory drawing showing an event when the quantum state ρ_{c} is |0><0|, and FIG. 2C is an explanatory drawing showing a quantum mechanical superposition of the order in which the quantum state ρ_{c} passes through a channel N₁ and the order in which the quantum state ρ_{c} passes through a channel N₂; and

FIG. 3 is an explanatory drawing showing the principle for estimating the amount of phase change by the phase change amount estimation device shown in FIG. 1.

### DESCRIPTION OF EMBODIMENTS

Hereinafter, in order to explain the present disclosure in greater detail, an embodiment of the present disclosure will be explained with reference to the accompanying drawings.

### Embodiment 1

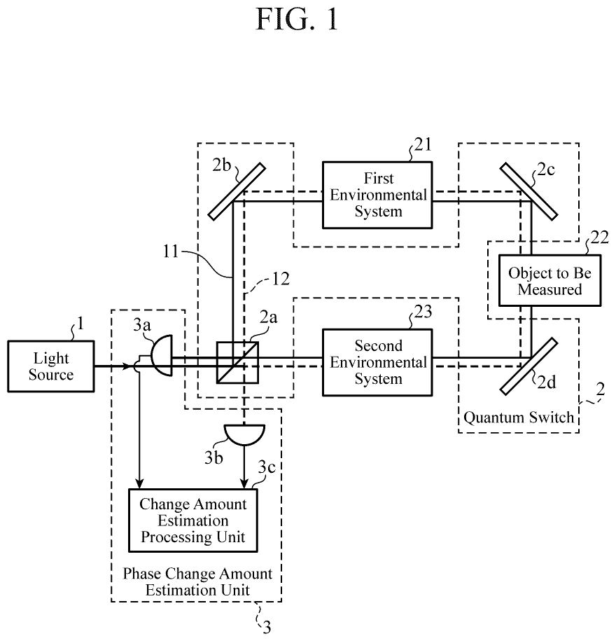

FIG. 1 is a block diagram showing a phase change amount estimation device according to Embodiment 1.

The phase change amount estimation device shown in FIG. 1 includes a light source 1, a quantum switch 2, and a phase change amount estimation unit 3.

The light source 1 is an incoherent light source that emits incoherent light toward the quantum switch 2. As the incoherent light source, there is a lamp light source or a light emitting diode (LED) light source, for example. As the state of the incoherent light, there is a single photon state, a two-level state, or a thermal equilibrium state, for example.

In the phase change amount estimation device shown in FIG. 1, the light source 1 is an incoherent light source that emits incoherent light. However, this is only an example, and the light source 1 may be a coherent light source that emits coherent light.

The quantum switch 2 implements a quantum mechanical superposition of the causal order of events.

Before explaining a concrete configuration of the quantum switch 2, the concept of a quantum mechanical superposition will be explained briefly.

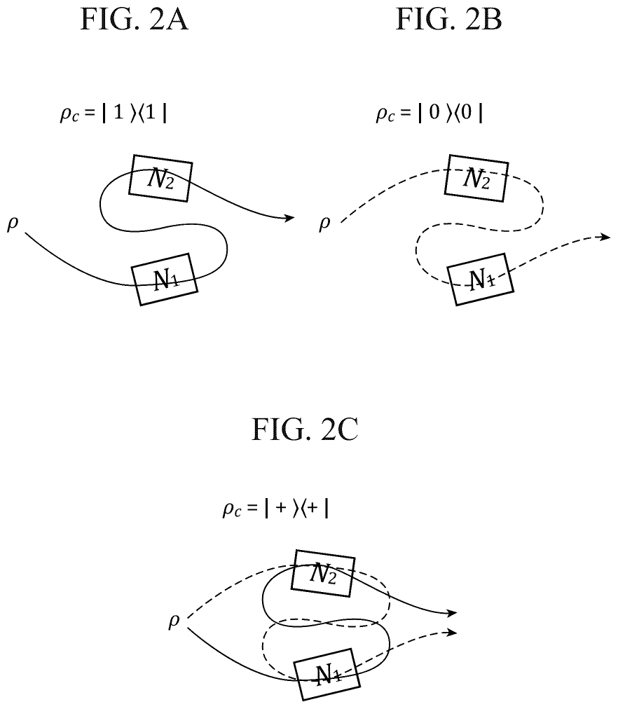

Hereinafter, a quantum state pc as shown in FIGS. 2A to 2C is assumed.

The quantum state pc is a two-level system, for example. As a combination in the two-level system, there is a combination of a vacuum state and a single photon state, for example.

FIG. 2A is an explanatory drawing showing an event when the quantum state ρ_{c} is |1><1|. |1><1| represents the single photon state, for example.

In the case where the quantum state ρ_{c} is |1><1|, the quantum state ρ passes through a channel N₂ after passing through a channel N₁ first, for example, as shown in FIG. 4.

FIG. 2B is an explanatory drawing showing an event when the quantum state ρ_{c} is |0><0|. |0><0| represents the vacuum state, for example.

In the case where the quantum state ρ_{c} is |0><0|, the quantum state ρ passes through the channel N₁ after passing through the channel N₂ first, for example, as shown in FIG. 2B.

The quantum switch generates a qubit showing a superposition state such as ρ_{c}=|+><+| (see FIG. 2C), as an event which is a superposition of the event shown in FIG. 2A and the event shown in FIG. 2B. FIG. 2C is an explanatory drawing showing a quantum mechanical superposition of the order in which the quantum state ρ_{c} passes through the channel N₁ and the order in which the quantum state ρ_{c} passes through the channel N₂.

It is expected that the quantum mechanical superposition of the quantum states ρ_{c} improves the accuracy of quantum measurements because the order in which the quantum state ρ passes through the two channels Nᵢ and N₂ is correlated with the state of the qubit.

The quantum switch 2 includes an optical demultiplexer 2a, a first reflector 2b, a second reflector 2c, and a third reflector 2d.

The quantum switch 2 outputs the light emitted from the light source 1 to either a first optical path 11 or a second optical path 12 in accordance with the quantum state of the light emitted from the light source 1.

In the first optical path 11, the light emitted from the light source 1 is made to pass through in the order of a first environmental system 21, an object to be measured 22, and a second environmental system 23. In the figure, the first optical path 11 is expressed by a solid line, and is the clockwise path.

In the second optical path 12, the light emitted from the light source 1 is made to pass through in the order of the second environmental system 23, the object to be measured 22, and the first environmental system 21. In the figure, the second optical path 12 is expressed by a broken line, and is the counterclockwise path.

In the phase change amount estimation device shown in FIG. 1, the quantum switch 2 outputs the light emitted from the light source 1 to either the first optical path 11 or the second optical path 12 in accordance with the quantum state of the light emitted from the light source 1. However, the output destination of the light controlled by the quantum switch 2 may be determined by not only the quantum state of the light emitted from the light source 1, but also the ambient noise in the vicinity of the quantum switch 2 or the position of the object to be measured 22, for example. The output destination of the light controlled by the quantum switch 2 may differ in accordance with whether or not the object to be measured 22 is positioned between the first environmental system 21 and the second environmental system 23, or whether or not the object to be measured 22 is positioned to interact with the two environmental systems, for example.

The optical demultiplexer 2a includes a beam splitter.

The optical demultiplexer 2a reflects the light emitted from the light source 1 or allows the light emitted from the light source 1 to pass therethrough, in accordance with the quantum state of the light emitted from the light source 1.

In the phase change amount estimation device shown in FIG. 1, the optical demultiplexer 2a outputs the light emitted from the light source 1 to the first optical path 11 by reflecting the light. The optical demultiplexer 2a outputs the light emitted from the light source 1 to the second optical path 12 by allowing the light to pass therethrough.

The optical demultiplexer 2a also outputs either the light which has passed through the first optical path 11 or the light which has passed through the second optical path 12 to the phase change amount estimation unit 3.

In the case where the beam splitter included in the optical demultiplexer 2a is implemented by a half mirror, for example, the light outputted from the half mirror to the first optical path 11 appears with a probability of 50% while the light outputted from the half mirror to the second optical path 12 appears with a probability of 50%. As a result, the light whose intensity is detected by a first optical detector 3a which will be mentioned later appears with a probability of 50% while the light whose intensity is detected by a second optical detector 3b which will be mentioned later appears with a probability of 50%.

The first reflector 2b is implemented by a total reflection mirror, for example.

The first reflector 2b is arranged between the optical demultiplexer 2a and the first environmental system 21.

The first reflector 2b totally reflects either the light which has passed through the first optical path 11 or the light which has passed through the second optical path 12.

The second reflector 2c is implemented by a total reflection mirror, for example.

The second reflector 2c is arranged between the first environmental system 21 and the object to be measured 22.

The second reflector 2c totally reflects either the light which has passed through the first optical path 11 or the light which has passed through the second optical path 12.

The third reflector 2d is implemented by a total reflection mirror, for example.

The third reflector 2d is arranged between the object to be measured 22 and the second environmental system 23.

The third reflector 2d totally reflects either the light which has passed through the first optical path 11 or the light which has passed through the second optical path 12.

In the phase change amount estimation device shown in FIG. 1, each of the first, second, and third reflectors 2b, 2c, and 2d is implemented by a total reflection mirror. Each of the first, second, and third reflectors 2b, 2c, and 2d only needs to have a reflectivity within a range that poses no practical issues, and is not limited to a total reflection mirror.

The phase change amount estimation unit 3 includes the first optical detector 3a, the second optical detector 3b, and a change amount estimation processing unit 3c.

The phase change amount estimation unit 3 estimates the amount of phase change in the light, the phase change being caused because of the light passing through the object to be measured 22, from either the light which has passed through the first optical path 11 or the light which has passed through the second optical path 12.

The first optical detector 3a detects the intensity of the light which has passed through the first optical path 11.

The first optical detector 3a outputs a result of the intensity detection to the change amount estimation processing unit 3c.

The second optical detector 3b detects the intensity of the light which has passed through the second optical path 12.

The second optical detector 3b outputs a result of the intensity detection to the change amount estimation processing unit 3c.

The change amount estimation processing unit 3c is implemented by a single circuit, a composite circuit, a programmable processor, a parallel programmable processor, an application specific integrated circuit (ASIC), a field-programmable gate array (FPGA), or a combination of these circuits, for example.

The change amount estimation processing unit 3c estimates the amount of phase change in the light, the phase change being caused because of the light passing through the object to be measured 22, from either the intensity of the light detected by the first optical detector 3a or the intensity of the light detected by the second optical detector 3b.

The first environmental system 21 is contained in both a middle part of the first optical path 11 and a middle part of the second optical path 12.

The first environmental system 21 is arranged between the first reflector 2b and the second reflector 2c.

The first environmental system 21 is in a thermal equilibrium state whose initial state is at absolute zero, for example.

The first environmental system 21 may be an environment that causes light to lose energy when passing through the first environmental system 21. However, because the period during which the optical system on the input side of the first environmental system 21 interacts with the first environmental system 21 is very short, a Markov approximation is established between that optical system and the first environmental system 21.

The object to be measured 22 has a property of changing the phase of light when the light passes therethrough.

The second environmental system 23 is contained in both a middle part of the first optical path 11 and a middle part of the second optical path 12.

The second environmental system 23 is arranged between the third reflector 2d and the optical demultiplexer 2a.

The second environmental system 23 may be an environment that causes light to lose energy when passing through the second environmental system 23.

The state of the second environmental system 23 may be the same as or different from that of the first environmental system 21. However, because the period during which the optical system on the input side of the second environmental system 23 interacts with the second environmental system 23 is very short, a Markov approximation is established between that optical system and the second environmental system 23.

Next, the operation of the phase change amount estimation device shown in FIG. 1 will be explained.

First, the light source 1 emits incoherent light toward the optical demultiplexer 2a of the quantum switch 2.

The optical demultiplexer 2a reflects the light emitted from the light source 1 or allows the light emitted from the light source 1 to pass therethrough.

The optical demultiplexer 2a reflects the light emitted from the light source 1, thereby outputting that light to the first optical path 11, or allows the light emitted from the light source 1 to pass therethrough, thereby outputting that light to the second optical path 12.

Whether the light emitted from the light source 1 is outputted by the optical demultiplexer 2a to either the first optical path 11 or the second optical path 12 is determined by the quantum state of the light emitted from the light source 1.

The light outputted from the optical demultiplexer 2a to the first optical path 11 is totally reflected by the first reflector 2b, and then reaches the first environmental system 21.

The light which has reached the first environmental system 21 is totally reflected by the second reflector 2c after passing through the first environmental system 21, and then reaches the object to be measured 22.

The light which has reached the object to be measured 22 passes through the object to be measured 22.

The phase of that light changes when it passes through the object to be measured 22.

The light whose phase has changed because of passing through the object to be measured 22 is totally reflected by the third reflector 2d and then reaches the second environmental system 23.

The light which has reached the second environmental system 23 reaches the optical demultiplexer 2a after passing through the second environmental system 23.

The optical demultiplexer 2a allows the light which has passed through the second environmental system 23 to pass therethrough, thereby outputting that light to the first optical detector 3a.

The light outputted from the optical demultiplexer 2a to the second optical path 12 reaches the second environmental system 23.

The light which has reached the second environmental system 23 is totally reflected by the third reflector 2d after passing through the second environmental system 23, and then reaches the object to be measured 22.

The light which has reached the object to be measured 22 passes through the object to be measured 22. The phase of that light changes when it passes through the object to be measured 22.

The light whose phase has changed because of passing through the object to be measured 22 is totally reflected by the second reflector 2c and then reaches the first environmental system 21.

The light which has reached the first environmental system 21 is totally reflected by the first reflector 2b after passing through the first environmental system 21, and then reaches the optical demultiplexer 2a.

The optical demultiplexer 2a allows the light totally reflected by the first reflector 2b to pass therethrough, thereby outputting that light to the second optical detector 3b.

The first optical detector 3a detects the intensity of the light which has passed through the first optical path 11, and outputs a result of the intensity detection to the change amount estimation processing unit 3c.

The second optical detector 3b detects the intensity of the light which has passed through the second optical path 12, and outputs a result of the intensity detection to the change amount estimation processing unit 3c.

The change amount estimation processing unit 3c estimates the amount of phase change in the light, the phase change being caused because of the light passing through the object to be measured 22, from either the intensity of the light detected by the first optical detector 3a or the intensity of the light detected by the second optical detector 3b.

Hereinafter, the principle for estimating the amount of phase change by the phase change amount estimation device shown in FIG. 1 will be explained.

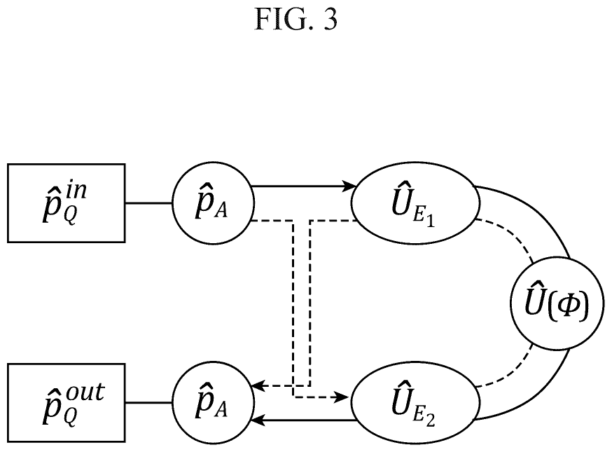

FIG. 3 is an explanatory drawing showing the principle for estimating the amount of phase change by the phase change amount estimation device shown in FIG. 1.

In FIG. 3, an input optical system ρ hat _{Q}ⁱⁿ is a density operator showing the state of the incoherent light emitted from the light source 1 to the quantum switch 2. In the document of the specification, because the symbol “\hat{ }” cannot be attached to any character, such a character with the symbol is denoted by characters like ρ hat.

An auxiliary system ρ hat _{A} shows a density operator showing the state of each of the following light beams: the incoherent light emitted from the light source 1, the light which has passed through the first optical path 11, and the light which has passed through the second optical path 12. The auxiliary system ρ hat _{A} is a two-level system, for example. It is assumed that the basis vectors of the quantum states in the two-level system are denoted by |0_{A}> and |1_{A}>.

U hat _{E1} is a unitary operator showing the time development of the state by the first environmental system 21, and U hat _{E2} is a unitary operator showing the time development of the state by the second environmental system 23.

U hat (ϕ) is a unitary operator showing the time development of the state by the object to be measured 22.

An output optical system ρ hat _{Q}^{out} is the light whose intensity is detected by either the first optical detector 3a or the second optical detector 3b.

In the case where the basis vector of the quantum state of the auxiliary system ρ hat _{A} is |0_{A}>, the input optical system ρ hat _{Q}ⁱⁿ is outputted to the first optical path 11 by the optical demultiplexer 2a.

After interacting with the first environmental system U hat _{E1}, the phase of the input optical system ρ hat _{Q}ⁱⁿ outputted to the first optical path 11 is shifted by ϕ caused by the object to be measured U hat (ϕ).

After interacting with the second environmental system U hat _{E2}, the input optical system ρ hat _{Q}ⁱⁿ which has undergone the phase shift becomes the output optical system ρ hat _{Q}^{out}.

In the case where the basis vector of the quantum state of the auxiliary system ρ hat _{A} is |1_{A}>, the input optical system ρ hat _{Q}ⁱⁿ is outputted to the second optical path 12 by the optical demultiplexer 2a.

After interacting with the second environmental system U hat _{E2}, the phase of the input optical system ρ hat _{Q}ⁱⁿ outputted to the second optical path 12 is shifted by ϕ caused by the object to be measured U hat (ϕ).

After interacting with the first environmental system U hat _{E1}, the input optical system ϕ hat _{Q}ⁱⁿ which has undergone the phase shift becomes the output optical system ϕ hat _{Q}^{out}.

It is assumed that the initial state of the input optical system ϕ hat _{Q}ⁱⁿ is a superposition of, in the two-level system, the vacuum state and the single photon state, for example, and the initial state of each of the first and second environmental systems U hat _{E1} and U hat _{E2} is the thermal equilibrium state at absolute zero. In this case, the time of the interaction between the input optical system ρ hat _{Q}ⁱⁿ and the first environmental system U hat _{E1} is very short, and a Markov approximation is established. Further, the time of the interaction between the input optical system ρ hat _{Q}ⁱⁿ and the second environmental system U hat _{E2} is very short, and a Markov approximation is established.

At this time, the input optical system ρ hat _{Q}ⁱⁿ is expressed as in the following equation (1). Further, the auxiliary system ρ hat _{A} is expressed as in the following equation (3). In the equation (3), the auxiliary system ρ hat _{A} is expressed as |ϕ_{A}>.

$${\hat{ρ}}_{Q}^{in} = \vert {ψ}_{q} 〉 〈 {ψ}_{Q} \vert \qquad ( 1 )$$

$$\vert {ψ}_{Q} = ( \vert 0 〉 + \vert 1 〉 ) / \sqrt{2} \qquad ( 2 )$$

$$\vert {ψ}_{A} 〉 = ( \vert {0}_{A} 〉 + \vert {1}_{A} 〉 ) / \sqrt{2} \qquad ( 3 )$$

The optical system ρ hat _{QA}^{out} (ϕ) which has undergone the phase shift because of the object to be measured U hat (ϕ) after the input optical system ρ hat _{Q}ⁱⁿ and the environmental system U hat _{QEj} (j=1, 2) have interacted with each other is expressed as in the following equation (4).

$${\hat{ρ}}_{QA}^{out} ( ϕ ) = \hat{U} {\hat{ρ}}_{Q}^{in} \qquad ( 4 )$$

$$\hat{U} = {\hat{U}}_{{QE}_{2}} \hat{U} ( ϕ ) {\hat{U}}_{{QE}_{1}} ⊗ \vert {0}_{A} 〉 〈 {0}_{A} \vert + {Û}_{{QE}_{1}} \hat{U} ( ϕ ) {\hat{U}}_{{QE}_{2}} ⊗ \vert {1}_{A} 〉 〈 {1}_{A} \vert \qquad ( 5 )$$

In the equation (5), Û_{QE}_{ⱼ} represents an operator expressing time development by the environmental system Eⱼ, Û(ϕ) represents an operator expressing time development by a phase shift, and ⊗ is a symbol representing a tensor product.

The optical system ϕ hat _{QA}^{out} (ϕ) shown in the equation (4) is expressed as in the following equation (6).

$$\begin{matrix}{\hat{ρ}}_{QA}^{out} ( ϕ ) = \frac{1}{4} [ ( 2 - {e}^{- 4 κ t} ) \vert 0 〉 〈 0 \vert + {e}^{- 4 κ t} \vert 1 〉 〈 1 \vert + {e}^{- 2 ( κ - i ω ) t + i ϕ} \vert 0 〉 〈 1 \vert \\ + {e}^{- 2 ( κ + i ω ) t + i ϕ} \vert 1 〉 〈 0 \vert ] ⊗ ( \vert {0}_{A} 〉 〈 {0}_{A} \vert + \vert {1}_{A} 〉 〈 {1}_{A} \vert ) \\ + \frac{1}{4} [ 1 + f ( t , ϕ ) ( 1 - {e}^{- 4 κ t} ) \vert 0 〉 〈 0 \vert + {e}^{- 4 κ t} \vert 1 〉 〈 1 \vert \\ + {e}^{- 2 ( κ - i ω ) t + i ϕ} \vert 0 〉 〈 1 \vert + {e}^{- 2 ( κ + i ω ) t - i ϕ} \vert 1 〉 〈 0 \vert ⊗ ( \vert {0}_{A} 〉 〈 {0}_{A} \vert + \vert {1}_{A} 〉 〈 {1}_{A} \vert )\end{matrix} \qquad ( 6 )$$

$$f ( t , ϕ ) = \frac{2 {e}^{κ t} cos ( ω t + ϕ )}{1 + {e}^{- 2 κ t}} \qquad ( 7 )$$

In the equation (6), κ denotes a constant showing the noise in each of the first and second environmental systems U hat _{E1}and U hat _{E2}, and t denotes the time of the interaction between the input optical system ρ hat _{Q}ⁱⁿ and each of the first and second environmental systems U hat _{E1} and U hat _{E2}. e denotes the Napier's constant, and ω denotes an angular frequency.

As shown in FIG. 2A or 2B, the output optical system ρ hat _{Q}^{out} in the case of not using the quantum switch 2 is expressed as in the following equation (8).

$${\hat{ρ}}_{Q}^{out} ( ϕ ) = \frac{1}{4} [ ( 2 - {e}^{- 4 κ t} ) \vert 0 〉 〈 0 \vert + {e}^{- 4 κ t} \vert 1 〉 〈 1 \vert + {e}^{- 2 ( κ - i ω ) t + i ϕ} \vert 0 〉 〈 1 \vert + {e}^{- 2 ( κ + i ω ) t + i ϕ} \vert 1 〉 〈 0 \vert ] \qquad ( 8 )$$

The output optical system ρ hat _{Q}^{out} in the case where the intensity of the light detected by either the first optical detector 3a or the second optical detector 3b is +1 is expressed as in the following equation (9).

The output optical system ρ hat _{Q}^{out} in the case where the intensity of the light detected by either the first optical detector 3a or the second optical detector 3b is −1 is expressed as in the following equation (10).

$${\hat{ρ}}_{Q}^{out} ( ϕ ) = \frac{〈 + \vert {\hat{ρ}}_{QA}^{out} \vert + 〉}{{P}^{+}} \qquad ( 9 )$$

$${\hat{ρ}}_{Q}^{out -} ( ϕ ) = \frac{〈 - \vert {\hat{ρ}}_{QA}^{out} \vert - 〉}{{P}^{-}} \vert 0 〉 〈 0 \vert \qquad ( 10 )$$

In the equation (9), P⁺ is the probability in the case where +1 is detected as the result of the detection of the intensity of the light when the quantum switch 2 is used. The use of the quantum switch 2 means that a basis |+><+|. |−><−| which is a projection measurement is performed on the auxiliary system ρ hat _{A}.

In the equation (10), P⁻ is the probability in the case where −1 is detected as the result of the detection of the intensity of the light when the quantum switch 2 is used.

The output optical system ρ hat _{Q}^{out} in the case where the intensity of the light detected by either the first optical detector 3a or the second optical detector 3b is −1 does not contain information showing the amount of phase change ϕ, the phase change being caused because of the light passing through the object to be measured U hat ϕas shown in the equation (10).

The probability P(+|ϕ) (=P⁺) that +1 is detected as the result of the detection of the intensity of the light is expressed as in the following equation (11).

The change amount estimation processing unit 3c determines the probability P(+|ϕ) shown in the equation (11) as the probability P(+|ϕ) that +1 is detected by either the first optical detector 3a or the second optical detector 3b. Because the constant κ showing the noise and the interaction time t are known, only the amount of phase change ϕ is unknown in the equation (11). Therefore, the change amount estimation processing unit 3c can estimate the amount of phase change ϕ from the probability P(+|ϕ) shown in the equation (11).

$$P ( + \vert ϕ ) = \frac{1}{2} [ 1 + {e}^{- 4 κ t} + \frac{1}{2} [ 1 + f ( t , ϕ ) ] ( 1 + {e}^{- 4 kt} ) ] \qquad ( 11 )$$

The Fisher information F_{Q} in the two-level system is expressed as in the following equation (12).

$${F}_{Q} = {\vert {\partial }_{θ} \vec{r} \vert}^{2} + \frac{{\vert \vec{r} \cdot {\partial }_{θ} \vec{r} \vert}^{2}}{1 - {\vert {\partial }_{θ} \vec{r} \vert}^{2}} ( \vert \hat{r} \vert \neq 1 ) \qquad ( 12 )$$

$${F}_{Q} = {\vert {\partial }_{θ} \vec{r} \vert}^{2} ( \vert \vec{r} \vert \neq 1 )$$

$$\vec{r} = ( u , v , w ) \qquad ( 13 )$$

In the equation (13), u, v, and w are the components of a Bloch vector.

The Bloch vector r shown in the equation (13) is determined from the following equation (14).

$$\hat{ρ} = \frac{1}{2} ( Î + \vec{r} \cdot \hat{σ} ) \qquad ( 14 )$$

In the equation (14), \hat{σ} represents a Pauli matrix and is expressed as in the following equation (15).

$$\hat{σ} ( {\hat{σ}}_{x} , {\hat{σ}}_{y} , {\hat{σ}}_{z} ) \qquad ( 15 )$$

The Fisher information F_{Q} contained in the output optical system ρ hat _{Q}^{out} shown in the equation (9) can be determined from the Bloch vector r. The Fisher information F_{Q} contained in the output optical system ρ hat _{Q}^{out} shown in the equation (9) is expressed as in the following equation (16).

$${F}_{Q} = {u}^{2} ( t , ϕ ) + {v}^{2} ( t , ϕ ) + \frac{{g}^{2} ( t , ϕ ) [ 1 + w ( t , ϕ ) ]}{1 - {\vert \vec{r} ( t , ϕ ) \vert}^{2}} \qquad ( 16 )$$

$$g ( t , ϕ ) = \frac{\frac{1}{2} {\partial }_{θ} f ( t , ϕ ) ( 1 - {e}^{- 4 κ t} )}{1 + {e}^{- 4 κ t} + \frac{1}{2} [ 1 + f ( t , ϕ ) ] ( 1 - {e}^{- 4 κ t} )} \qquad ( 17 )$$

$$f ( t , ϕ ) = \frac{2 {e}^{- κ t} cos ( ω t + ϕ )}{1 + {e}^{- 2 κ t}} \qquad ( 18 )$$

$$u ( t , ϕ ) = \frac{2 {e}^{- κ t} cos ( 2 ω t + ϕ )}{1 + {e}^{- 4 κ t} + \frac{1}{2} [ 1 + f ( t , ϕ ) ] ( 1 - {e}^{- 4 κ t} )} \qquad ( 19 )$$

$$u ( t , ϕ ) = \frac{2 {e}^{- κ t} sin ( 2 ω t + ϕ )}{1 + {e}^{- 4 κ t} + \frac{1}{2} [ 1 + f ( t , ϕ ) ] ( 1 - {e}^{- 4 κ t} )} \qquad ( 20 )$$

$$w ( t , ϕ ) = \frac{1 - {e}^{- 4 κ t} + \frac{1}{2} [ 1 + f ( t , ϕ ) ] ( 1 - {e}^{- 4 κ t} )}{1 + {e}^{- 4 κ t} + \frac{1}{2} [ 1 + f ( t , ϕ ) ] ( 1 - {e}^{- 4 κ t} )} \qquad ( 21 )$$

The average F bar _{Q} of the Fisher information F_{Q} contained in the output optical system _{Q} hat gout shown in the equation (9) is expressed as in the following equation (22). In the document of the specification, because the symbol “−” cannot be attached to any character, such a character with the symbol is denoted by characters like F bar.

$${\overline{F}}_{Q} = {F}_{Q} {P}^{+} \qquad ( 22 )$$

$${P}^{+} = \frac{1}{2} [ 1 + {e}^{- 4 κ t} + \frac{1}{2} [ 1 + f ( t , ϕ ) ] ( 1 - {e}^{- 4 κ t} ) ] \qquad ( 23 )$$

The Fisher information F₀ when not using the quantum switch 2 is expressed as in the following equation (24) from both the output optical system ρ hat _{Q}^{out} shown in the equation (8) when not using the quantum switch 2, and the Fisher information F_{Q} in the two-level system shown in the equation (12).

The phase change amount estimation device disclosed in Patent Literature 1 does not use the quantum switch 2. Therefore, if the noise conditions of the environmental system and the time of the interaction between light and the environmental system in the phase change amount estimation device disclosed in Patent Literature 1 are the same as the noise conditions and the interaction time which are associated with the equation (8), respectively, the Fisher information contained in the intensity of the light measured by the light intensity measurement means disclosed in Patent Literature 1is expressed substantially as in the following equation (24).

$${F}_{0} = {e}^{- 4 k t} \qquad ( 24 )$$

The average F bar _{Q} of Fisher information F_{Q} shown in the equation (22) is expressed as in the following equation (25).

$$\begin{matrix}{\overline{F}}_{Q} = {P}^{+} [ {u}^{2} ( t , ϕ ) + {v}^{2} ( t , ϕ ) + \frac{{g}^{2} ( t , ϕ ) [ 1 + w ( t , ϕ ) ]}{1 - {\vert \vec{r} ( t , ϕ ) \vert}^{2}} ] \\ \geq {P}^{+} [ {u}^{2} ( t , ϕ ) + {v}^{2} ( t , ϕ ) ] \\ = \frac{4 {F}_{0}}{{P}^{+}} \\ \geq {F}_{0}\end{matrix} \qquad ( 25 )$$

As can be seen from a comparison between the equation (24) and the equation (25), the Fisher information F_{Q} in the case of using the quantum switch 2 is greater than or equal to the Fisher information F₀ when not using the quantum switch 2.

Therefore, in the case of using the quantum switch 2, the estimation accuracy of the phase change ϕ improves compared to that in the case of not using the quantum switch 2.

When a result of the estimation of the amount of phase change ϕ by the phase change amount estimation device shown in FIG. 1 is outputted to an external device, for example, the external device can identify the properties of the object to be measured 22 from the estimation result of the amount of phase change ϕ.

Further, the external device can determine the presence or absence of the amount of phase change ϕ caused by the object to be measured 22 from the estimation result of the amount of phase change ϕ. As a result, because the external device can determine whether the object to be measured 22 is present, the phase change amount estimation device shown in FIG. 1 can be used as a sensing device.

As described above, a phase change amount estimation device according to Embodiment 1 includes: a light source 1 to emit incoherent light; a quantum switch having an optical demultiplexer 2a, the incoherent light emitted from the light source 1 entering an incident surface of the optical demultiplexer, the optical demultiplexer being configured to reflect the incoherent light or allow the incoherent light to pass through the optical demultiplexer, the quantum switch having environmental system 21, and a second environmental system 23, an object to be measured 22 being arranged between the first environmental system 21 and the second environmental system 23, and, by the quantum switch, a quantum mechanical superposition is achieved by forming either one of a first optical path 11 in which the incoherent light, after being reflected by the optical demultiplexer 2a, is made to pass through in an order of a first environmental system 21, an object to be measured 22, and a second environmental system 23, or a second optical path 12 in which the incoherent light passed through the optical demultiplexer 2a is made to pass through in an order of the second environmental system 23, the object to be measured 22, and the first environmental system 21; and a phase change amount estimator 3 having a first optical detector to detect intensity of the incoherent light which has passed through the first optical path 11 and a second optical detector to detect intensity of the incoherent light which has passed through the second optical path 12, and to estimate an amount of phase change in a light, the phase change being caused by the light passing through the object to be measured 22. Therefore, it is possible to improve the estimation accuracy of the amount of phase change by increasing the Fisher information.

It is to be understood that changes can be made in any component of the embodiment, or any component of the embodiment can be omitted.

### INDUSTRIAL APPLICABILITY

The present disclosure is suitable for phase change amount estimation devices.

### REFERENCE SIGNS LIST

1 light source, 2 quantum switch, 2a optical demultiplexer, 2b first reflector, 2c second reflector, 2d third reflector, 3 phase change amount estimation unit, 3a first optical detector, 3b second optical detector, 3c change amount estimation processing unit, 11 first optical path, 12 second optical path, 21 first environmental system, 22 object to be measured, and 23 second environmental system.

1. A phase change amount estimation device comprising:
a light source to emit incoherent light;
a quantum switch having an optical demultiplexer, the incoherent light emitted from the light source entering an incident surface of the optical demultiplexer, the optical demultiplexer being configured to reflect the incoherent light or allow the incoherent light to pass through the optical demultiplexer, the quantum switch having a first environmental system, and a second environmental system, an object to be measured being arranged between the first environmental system and the second environmental system, and, by the quantum switch, a quantum mechanical superposition is achieved by forming either one of a first optical path in which the incoherent light, after being reflected by the optical demultiplexer, is made to pass through in an order of a first environmental system, an object to be measured, and a second environmental system, or a second optical path in which the incoherent light passed through the optical demultiplexer is made to pass through in an order of the second environmental system, the object to be measured, and the first environmental system; and
a phase change amount estimator having a first optical detector to detect intensity of the incoherent light which has passed through the first optical path, a second optical detector to detect intensity of the incoherent light which has passed through the second optical path, and a change amount estimation processing circuitry to estimate an amount of phase change in a light, the phase change being caused by the light passing through the object to be measured, from the intensity of the light detected by the first optical detector or the intensity of the light detected by the second optical detector.

2. The phase change amount estimation device according to claim 1, wherein the incoherent light is a light in a single photon state, a two-level state, or a thermal equilibrium state.

3. The phase change amount estimation device according to claim 1, wherein the quantum switch has:
a first reflector arranged between the optical demultiplexer and the first environmental system;
a second reflector arranged between the first environmental system and the object to be measured; and
a third reflector arranged between the object to be measured and the second environmental system,
wherein the optical demultiplexer outputs the incoherent light which has passed through the first optical path to the first optical detector and outputs the incoherent light which has passed through the second optical path to the second optical detector.

4. The phase change amount estimation device according to claim 3, wherein the optical demultiplexer has a beam splitter.

5. The phase change amount estimation device according to claim 1, wherein the quantum switch implement a quantum mechanical superposition of a quantum state of the light of a causal order of events by changing an order of the first environmental system, the object to be measured, and the second environmental system through which the incoherent light passes through in accordance with the quantum state of the incoherent light; and
the phase change amount estimator estimates the amount of phase change caused by the light passing through the object to be measured on a basis of the intensity of the light detected by the first optical detector or the second optical detector and a probability with which the intensity appears.
